(19) United States
(12) Patent Application Publication
(10) Pub. No.: US 2016/0147765 A1
(43) Pub. Date: May 26, 2016

(54) Techniques for Using Similarity to Enhance Relevance in Search Results

(71) Applicant: Quixey, Inc., Mountain View, CA (US)

(72) Inventor: Eric J. Glover, Palo Alto, CA (US)

(73) Assignee: Quixey, Inc., Mountain View, CA (US)

(21) Appl. No.: 14/863,144

(22) Filed: Sep. 23, 2015

Related U.S. Application Data
(60) Provisional application No. 62/084,239, filed on Nov. 25, 2014.

(51) Int. Cl. G06F 17/30

(52) U.S. Cl. CPC G06F 17/3053; G06F 17/30554; G06F 17/30589

(57) ABSTRACT

Techniques include receiving a search query from a user device, performing a search for software applications using the search query, and generating a preliminary set of one or more software applications identified during the search. The techniques further include generating a similarity set of one or more software applications that are each similar to at least one of the one or more software applications of the preliminary set, generating a modified set of one or more software applications based on the preliminary set and the similarity set, and transmitting the modified set to the user device. In some examples, generating the modified set based on the preliminary set and the similarity set includes one or more of increasing a rank value of an existing software application included in the preliminary set, and adding a new software application not included in the preliminary set to the preliminary set.

### CROSS REFERENCE TO RELATED APPLICATIONS

This U.S. patent application claims priority under 35 U.S.C. §119(e) from, U.S. Provisional Application 62/084,239, filed on Nov. 25, 2014, which is hereby incorporated by reference in its entirety.

### TECHNICAL FIELD

This disclosure relates generally to the field of software application search, and more particularly to techniques for modifying software application search results to enhance their relevance.

### BACKGROUND

Software applications that run on mobile computing devices have gained vast popularity in the United States and across the world. It is common for users to search for software applications based on the functions the applications provide. As such, users often approach software application search using broad and/or categorical search queries. Most software application search engines use text-based retrieval components that omit from search results software applications that do not match users' search queries exactly, but nonetheless provide the functionality the users' desire.

### SUMMARY

In one example, a method includes receiving a search query from a user device, performing a search for software applications using the search query, and generating a preliminary set of one or more software applications identified during the search. The method further includes generating a similarity set of one or more software applications that are each similar to at least one of the one or more software applications of the preliminary set, generating a modified set of one or more software applications based on the preliminary set and based on the similarity set, and transmitting the modified set as part of search results to the user device.

In another example, a system includes one or more computing devices configured to receive a search query from a user device, perform a search for software applications using the search query, and generate a preliminary set of one or more software applications identified during the search. The one or more computing devices are further configured to generate a similarity set of one or more software applications that are each similar to at least one of the one or more software applications of the preliminary set, generate a modified set of one or more software applications based on the preliminary set and based on the similarity set, and transmit the modified set as part of search results to the user device.

In another example, a non-transitory computer-readable storage medium includes instructions that cause one or more computing devices to receive a search query from a user device, perform a search for software applications using the search query, and generate a preliminary set of one or more software applications identified during the search. The instructions further cause the one or more computing devices to generate a similarity set of one or more software applications that are each similar to at least one of the one or more software applications of the preliminary set, generate a modified set of one or more software applications based on the preliminary set and based on the similarity set, and transmit the modified set as part of search results to the user device.

### DESCRIPTION OF DRAWINGS

FIG. 1 is a schematic illustrating an example environment including a search system and a similarity system.

FIG. 2 is a functional block diagram of an example application search module.

FIGS. 3A and 3B are schematics illustrating example application records.

FIG. 4 is a flow diagram that illustrates an example set of operations for a method of performing an application search.

FIG. 5A is a schematic illustrating an example similarity set.

FIGS. 5B and 5C are schematics illustrating example similarity records.

FIG. 6 is a functional block diagram that illustrates example interactions between a search system and a similarity system.

FIG. 7 is a flow diagram that illustrates an example set of operations for a method of modifying application search results.

FIG. 8 is a functional block diagram that illustrates example interactions between a determination module, a search system, and a similarity system.

FIGS. 9A-9C are flow diagrams the illustrate example sets of operations for methods of implementing a determination module on a tiered basis.

Like reference symbols in the various drawings indicate like elements.

### DETAILED DESCRIPTION

The figures and the following description relate to example implementations by way of illustration only. It should be noted that from the following discussion, alternative implementations of the structures and methods disclosed herein will be readily recognized as viable alternatives that may be employed without departing from the scope of the disclosure. This disclosure describes techniques for modifying search results to enhance relevance using non-textual similarity between applications.

The present disclosure relates to searching for software applications (i.e., “applications”) and enhancing the relevance of search results by modifying application rank in search results based on similarity. A search system of the present disclosure can receive a search query from a user device, perform a search for software applications using the search query, and generate a set of preliminary results including a list of applications identified during the search. The search system can also retrieve a similarity set (e.g., from a similarity system) including a list of applications that are similar to the applications indicated by the preliminary results. The search system can further generate a set of modified results (hereafter, “modified result set”) by modifying the preliminary results based on the similarity set and/or the search query. The search system can also transmit the modified result set to the user device for rendering and displaying.

A similarity system of the present disclosure can receive a set of preliminary results and/or a search query (e.g., from a search system and/or a user device), identify applications similar to applications listed in the preliminary results, and generate a similarity set including the applications similar to the applications listed in the preliminary results. The similarity system can also score the applications in the similarity set by assigning each application in the similarity set a similarity score that quantifies a degree of similarity between the application and an application in the preliminary results.

As described herein, the search system can utilize a similarity set to modify preliminary results and thereby create a modified result set. In some implementations, the search system can create the modified result set by boosting a rank of each of one or more applications in the preliminary results relative to other applications in the preliminary results. In some implementations, creating the modified result set additionally, or alternatively, includes inserting one or more new applications not present in the preliminary results into the preliminary results.

The search system can be configured to modify the preliminary results on a selective and/or tiered basis. For example, the search system may be configured to modify the preliminary results for a limited, pre-defined set of search queries, or for any search query received by the search system from a user device. Additionally, or alternatively, the search system may dynamically modify the preliminary results based on a tiered approach that analyzes one or more of the search query, the preliminary results, the similarity set, and the modified result set before determining whether or not to provide a user device with search results that are boosted or inserted based on similarity in the manner described above.

In some implementations, the search system can determine whether or not to modify a set of preliminary results in the manner described herein based on a search query and/or the preliminary results. For example, the search system may determine that the search query is too narrow, or too specific, for the preliminary results to benefit from the modification techniques described herein and refrain from modifying the preliminary results. In other examples, the search system may determine that the preliminary results are unlikely to benefit from the modification techniques after the search system analyzes the preliminary results and also refrain from modifying the preliminary results. As one example, the search system may determine that the preliminary results are unlikely to benefit from the modification techniques if the applications of the preliminary results are too inconsistent, or too dissimilar, to each other. For example, if the search system receives the search query “frisbee prices” and generates a set of preliminary results containing applications that each perform a completely different function (e.g., a first application is a frisbee video game, a second application streams frisbee media, and a third application provides frisbee product reviews), the search system can refrain from modifying the preliminary results. In this example, any similar applications discovered using the modification techniques described herein are unlikely to increase the overall relevance of the preliminary results. Contrastingly, if the search system receives the search query “cheap hotels” and generates a set of preliminary results containing applications that each allow the user to book a hotel room, the search system can use the modification techniques described herein to discover applications that provide similar functionality despite using different textual descriptions (e.g., an application that uses the term “lodging” in its application description instead of the term “hotel room”). In scenarios where the search system determines that the preliminary results are unlikely to benefit from the modification techniques described herein (for lack of consistency/similarity, or otherwise), the search system may proceed to provide the preliminary results as search results to a user device without executing any of the modification techniques disclosed herein.

As also described herein, in some implementations, the search system can determine whether or not to modify a set of preliminary results based on a similarity set retrieved from the similarity system. For example, the search system may modify the preliminary results when the search system retrieves a high quality similarity set from the similarity system. The search system can be configured to identify a high quality similarity set (e.g., determine that a similarity set is of high quality) by comparing one or more similarity scores of applications in the similarity set against one or more pre-defined, or dynamically-defined threshold similarity scores.

In some implementations, the search system modifies a set of preliminary results and generate a modified result set, but nonetheless transmit search results that are based on the preliminary results that are not modified by the techniques disclosed herein. For example, the search system can transmit search results generated using the preliminary results instead of search results generated using the modified result set. In these implementations, the search system can determine whether to send search results that are based on the preliminary results, or search results that are based on the modified result set, by analyzing one or more of the search query, the preliminary results, the similarity set, and the modified result set. For example, the search system can analyze the modified result set against one or more of the search query, the preliminary results, and the similarity set to determine whether relevance of the modified result set was enhanced relative to the preliminary results by the modification process described herein. Based on this analysis, the search system can determine whether to provide a requesting user device with search results that are based on the preliminary results, the modified result set, or some other version or permutation of the preliminary results.

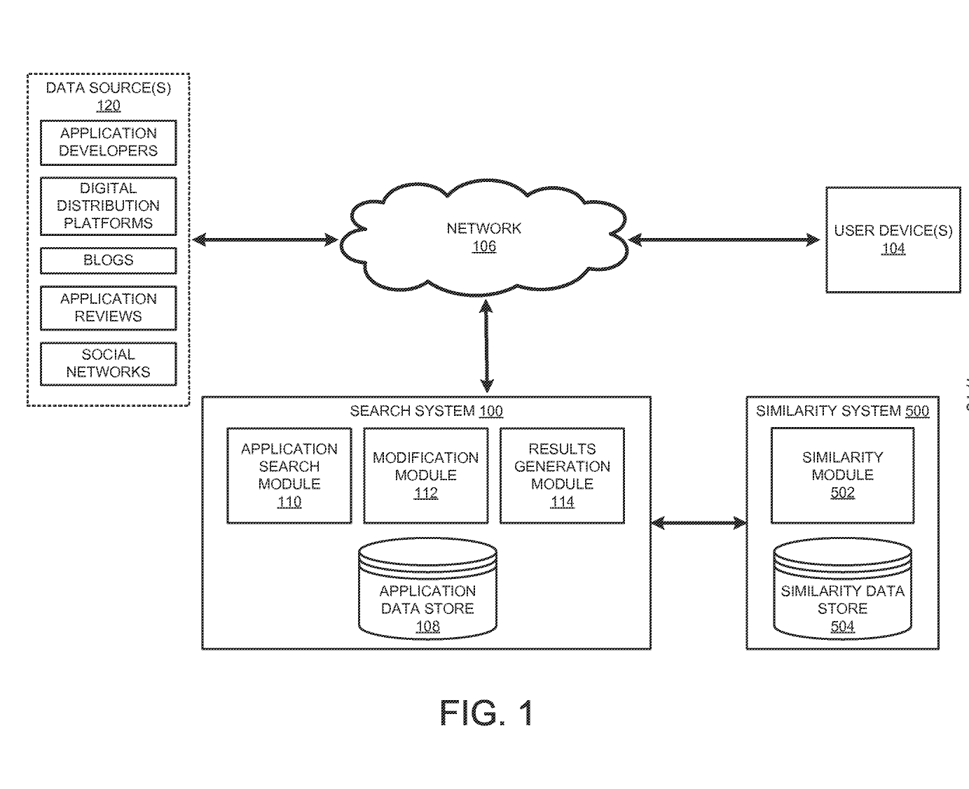

FIG. 1 is a functional block diagram illustrating an example environment that includes a search system 100 and a similarity system 500. The search system 100 is configured to perform searches for software applications using search queries received from user device(s) 104. The similarity system 500 is configured to identify software applications that are similar to software applications indicated by preliminary results generated by the search system 100 as part of performing the searches. A software application may refer to computer software that causes a computing device to perform a task. In some examples, a software application is referred to as an “application,” an “app,” or a “program.” Example applications include, but are not limited to, document viewing applications, messaging applications, media streaming applications, social networking applications, and games.

Applications can be executed on a variety of different computing devices. For example, applications can be executed on mobile computing devices, such as smart phones, tablets, and wearable computing devices (e.g., headsets and/or watches). Applications can also be executed on other types of computing devices having other form factors, such as laptop computers, desktop computers, or other consumer electronic devices. In some examples, applications are installed on a computing device prior to a user purchasing the computing device. In other examples, the user may download and install applications on the computing device.

The functionality of an application may be accessed on the computing device on which the application is installed. Additionally, or alternatively, the functionality of an application may be accessed via a remote computing device. In some examples, all of an application's functionality is included on the computing device on which the application is installed. These applications may function without communication with other computing devices (e.g., via the Internet). In other examples, an application installed on a computing device may access information from other remote computing devices during operation. For example, a weather application installed on a computing device may access the latest weather information via the Internet and display the accessed weather information to the user through the installed weather application. In still other examples, an application (e.g., a web-based application) may be partially executed by the user's computing device and partially executed by a remote computing device. For example, a web application may be an application that is executed, at least in part, by a web server and accessed by a web browser of the user's computing device. Example web applications may include, but are not limited to, web-based email, online auctions, and online retail sites.

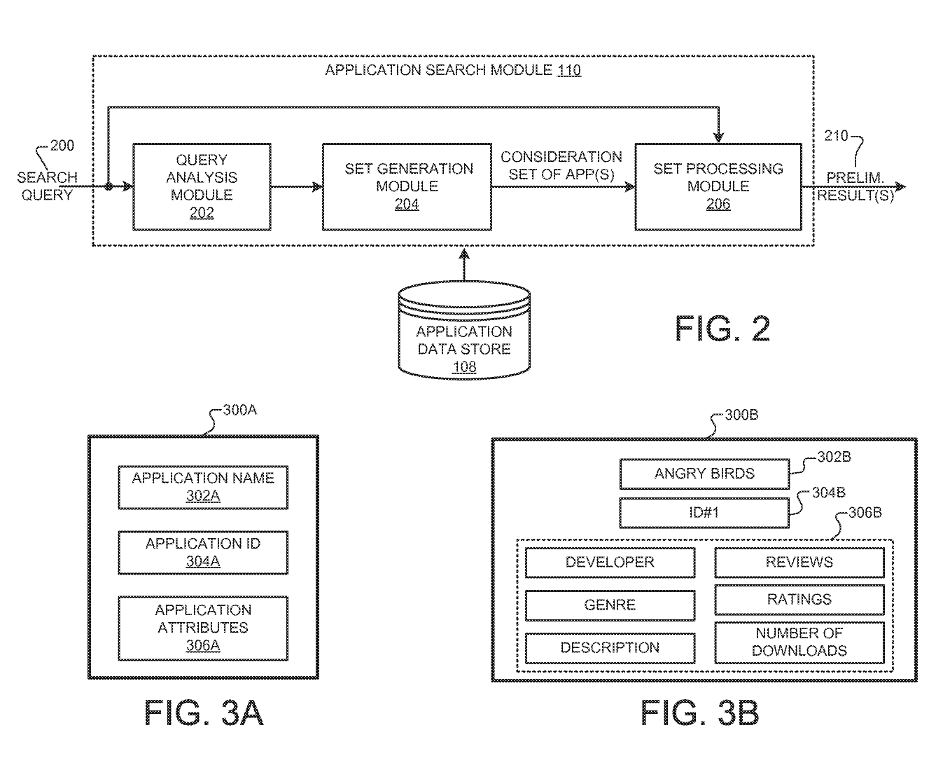

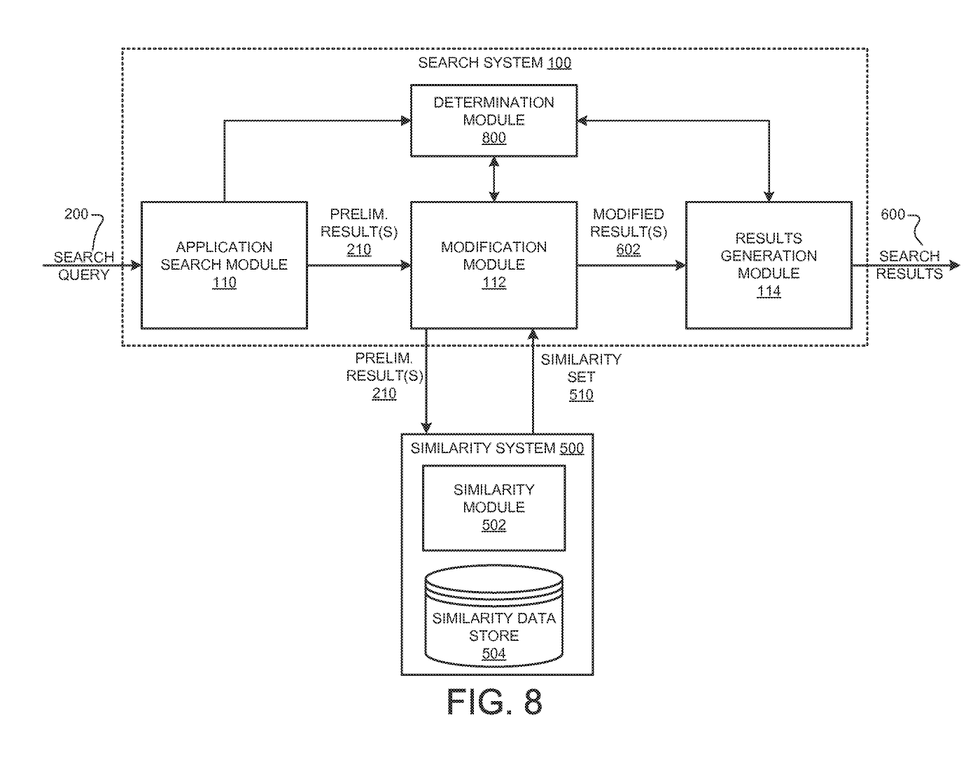

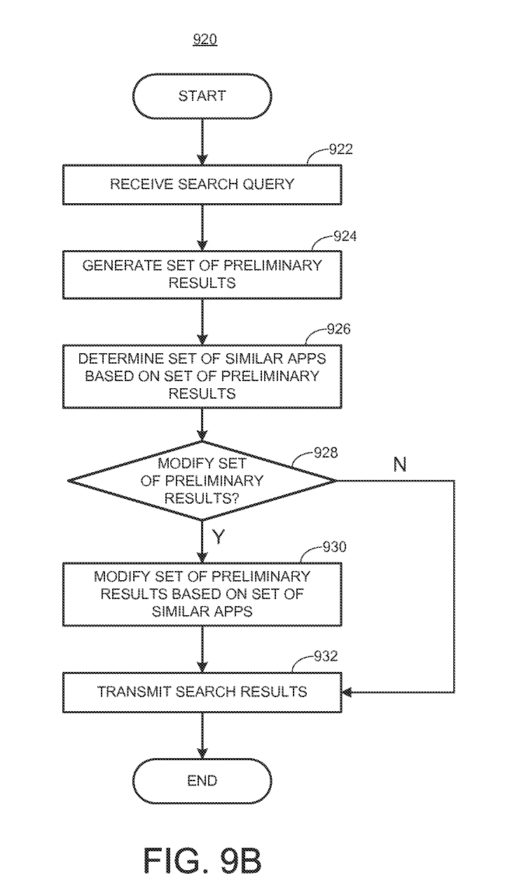

Returning to FIG. 1, the search system 100 is configured to receive search queries from one or more user devices 104 via a network 106. The search system 100 performs a search for applications in response to a received search query. The search may generate a set of one or more preliminary results (e.g., the preliminary result(s) 210 depicted in FIGS. 2, 6, and 8) that includes a list of applications, each of which is associated with a result score that indicates the rank of the application relative to the other applications in the list. In some implementations, the search system 100 obtains a similarity set (e.g., the similarity set 510 depicted in FIGS. 6 and 8) of one or more applications that are each similar to an application included in the preliminary results from the similarity system 500. In some examples, the search system 100 can modify the preliminary results based on the similarity set to create a modified result set (e.g., the modified result(s) 602 depicted in FIGS. 6 and 8). As described herein, the modified result set may include one or more applications included in the preliminary results whose rank has been increased and/or one or more additional applications. The search system 100 may then generate search results based on the modified result set and transmit the search results to the requesting user device 104.

The requesting user device 104 may display the search results to a user of the user device 104 as a list of one or more applications and allow the user to select one or more of the applications in the list in order to view information related to the applications and/or download the applications. The applications (e.g., executable programs) listed in the search results sent to the user device 104 may be accessible from (e.g., downloaded from) systems different than the search system 100. Put another way, the search system 100 may store data related to applications that are accessible in locations other than the search system 100. For example, the applications may be accessible from digital distribution platforms configured to distribute the applications. Example digital distribution platforms include, but are not limited to, GOOGLE PLAY® developed by Google Inc., the APP STORE® developed by Apple Inc., and WINDOWS PHONE STORE developed by Microsoft Corporation. Although the applications listed in the search results may be accessed in locations other than the search system 100, the search system 100 may include applications that are available for download.

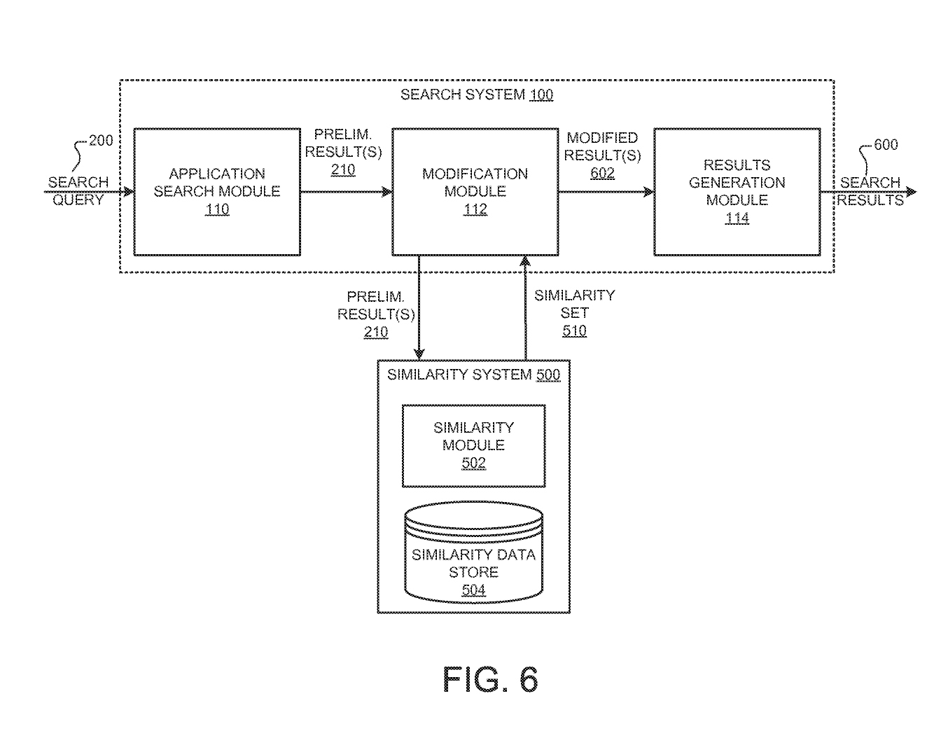

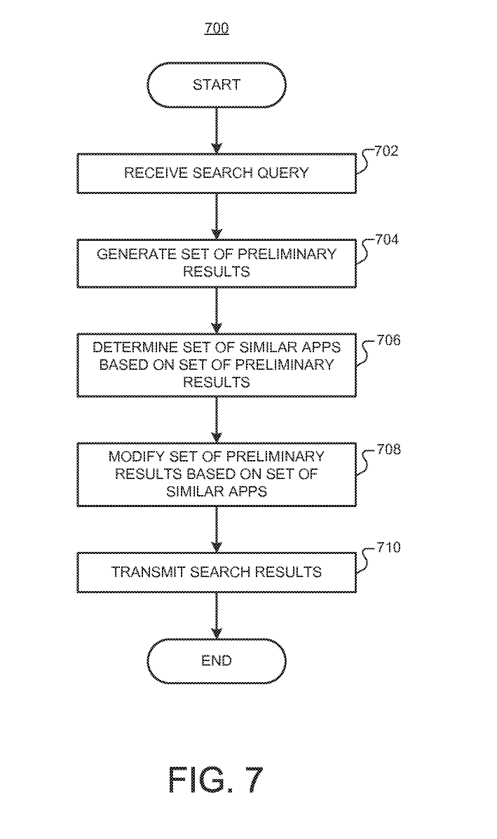

The similarity system 500 uses the preliminary results generated by the search system 100 to generate the similarity set of applications that are each similar to an application included in the preliminary results. For example, the similarity system 500 may generate a list of one or more applications that are similar to one or more applications included in the preliminary results generated by the search system 100. The similarity system 500 may transmit the similarity set to the search system 100. The search system 100 can use the similarity set to modify the preliminary results, whereby the search system 100 can either boost a rank of each of one or more applications in the preliminary results, or introduce one or more new applications into the preliminary results, as described herein. Modifying the preliminary results in this manner transforms the preliminary results into the modified result set. In this way, the search system 100 can leverage information that may not appear in textual descriptions of applications (i.e., information derived by analyzing conceptual similarity between applications) to enhance text-based application search and improve application search result relevance. Techniques for determining application similarity and using the application similarity to enhance relevance in application search results are described herein with reference to FIGS. 5-7.

FIG. 1 illustrates an example search system 100 including an application data store 108, an application search module 110, a modification module 112, and a results generation module 114. The application data store 108 includes a variety of different types of data related to different applications. The application data store 108 may include one or more databases, indices (e.g., inverted indices), files, or other data structures, which may be used to implement the techniques of the present disclosure. As described herein, the data included in the application data store 108 may include descriptions of applications, statistics related to applications (e.g., download numbers, review numbers, etc.), and other information. The application search module 110 receives a search query and generates search results based on the data included in the application data store 108. The modification module 112 modifies the preliminary results to generate the modified result sets. The results generation module 114 prepares search results for rendering and displaying and transmits the search results to the requesting user device 104. The results generation module 114 can prepare the search results based on the preliminary results, the modified result set, or any other suitable list or set of applications.

The similarity system 500 includes a similarity data store 504 and a similarity module 502. The similarity data store 504 includes data that indicates similarity between different applications. For example, the similarity data store 504 may include one or more similarity scores that each indicate a degree of similarity between an application included in the preliminary results and an application included in the similarity set. The similarity data store 504 may include one or more databases, indices (e.g., inverted indices), files, or other data structures, which may be used to implement the techniques of the present disclosure. The similarity system 500 may access the application data store 108 to populate and update the similarity data store 504. The similarity module 502 uses the similarity data store 504 to determine which applications are similar to applications the similarity module 502 receives from the search system 100 (i.e., the applications of the preliminary results).

The search system 100 and the similarity system 500 may communicate with each other, with the user device(s) 104, with the data source(s) 120, and/or with any other one or more suitable devices via the network 106. Examples of the user device(s) 104, the data source(s) 120, and the network 106 are now described in turn.

The user device(s) 104 can be any computing devices that are capable of providing search queries to the search system 100. The user device(s) 104 may include, but are not limited to, smart phones, tablet computers, laptop computers, and desktop computers. The user device(s) 104 may also include other computing devices having other form factors, such as computing devices included in vehicles, gaming devices, televisions, or other appliances (e.g., networked home automation devices).

The user device(s) 104 may use a variety of different operating systems. In an example where a user device 104 is a mobile device, the user device 104 may run an operating system including, but not limited to, ANDROID® developed by Google Inc., IOS® developed by Apple Inc., or WINDOWS PHONE® developed by Microsoft Corporation. In an example where a user device 104 is a laptop or desktop computing device, the user device 104 may run an operating system including, but not limited to, MICROSOFT WINDOWS® developed by Microsoft Corporation, MAC OS® developed by Apple Inc., or LINUX® (LINUX® is the registered trademark of Linus Torvalds in the U.S. and other countries). The user device(s) 104 may also access the search system 100 while running operating systems other than those operating systems described above, whether presently available or developed in the future.

The user device(s) 104 can communicate with the search system 100 via the network 106. In some examples, a user device 104 communicates with the search system 100 using an application installed on the user device 104. In general, a user device 104 may communicate with the search system 100 using any application that can transmit search queries to the search system 100. In some examples, a user device 104 runs an application that is dedicated to interfacing with the search system 100, such as an application dedicated to application searches. In other examples, a user device 104 may communicate with the search system 100 using a more general application, such as a web-browser application. The application may display a search field on a graphical user interface (GUI) into which the user may enter search queries. The user may enter a search query using a touchscreen or physical keyboard, a speech-to-text program, or other form of user input.

A search query entered into a GUI displayed on a user device 104 may include words, numbers, and/or symbols. In general, a search query may be a request for information retrieval (e.g., search results) from the search system 100. For example, a search query may be directed to retrieving a list of applications in implementations where the search system 100 is configured to generate a list of applications as search results. A search query directed to retrieving a list of applications may indicate a user's desire to retrieve applications that have a functionality implicated by the search query.

A user device 104 may receive a set of search results from the search system 100 that are responsive to the search query transmitted by the user device 104 to the search system 100. The user device 104 may display the search results via the GUI. The application running on the user device 104 may display the search results within the GUI in a variety of different manners, depending on what information is transmitted to the user device 104. In examples where the search results include a list of ranked applications, the search system 100 may transmit the list of applications to the user device 104. In this example, the GUI may display the search results to the user as a list of application names. In some examples, the search system 100 or other computing system, transmits additional information to the user device 104 including, but not limited to, application ratings, application download statistics, application screenshots, and application descriptions. In these examples, the GUI may display this information along with the list of application names. In some examples, the GUI displays the search results as a list of applications ordered from the top of the screen to the bottom of the screen, such that the list of applications is order by descending result scores. In some examples, the search results are displayed under the search field in which the user entered the search query. The GUI can display search results in the same manner whether or not they have been modified based on the techniques disclosed herein.

In some examples, the user device(s) 104 communicates with the search system 100 and the similarity system 500 via a partner computing system (not illustrated). The partner computing system may be a computing system of a third party that may leverage the search functionality of the search system 100 and the similarity functionality of the similarity system 500. The partner computing system may belong to a company or organization other than that which operates the search system 100 and/or similarity system 500. Example third parties, which may leverage the functionality of the search system 100 and the similarity system 500 may include, but are not limited to, internet search providers and wireless communications service providers. The user device(s) 104 may send search queries to the search system 100 and receive search results via the partner computing system. The partner computing system may provide a user interface to the user device(s) 104 in some examples and/or modify the search experience provided on the user device(s) 104.

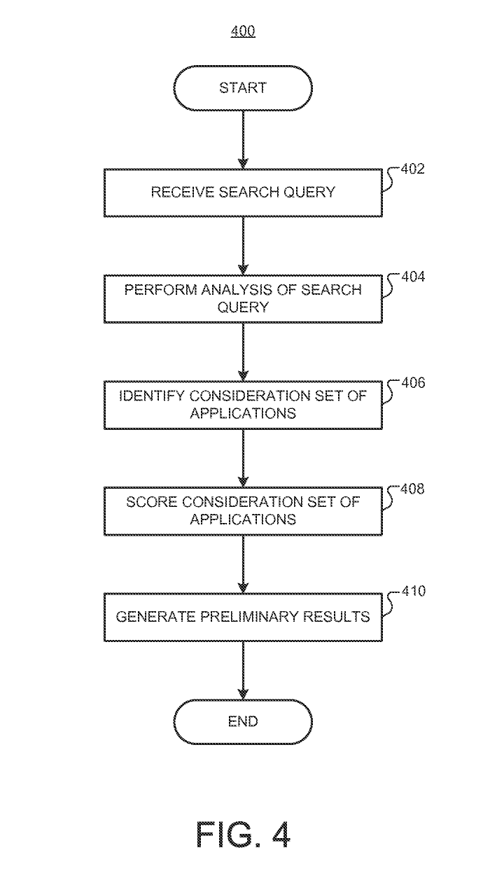

FIG. 1 illustrates one or more data sources 120. The data source(s) 120 may be sources of data, which the search system 100 may use to generate and update the application data store 108. For example, the search system 100 may use the data to update one or more databases, indices, files, or other data structures included in the application data store 108. The search system 100 may generate new application records (e.g., the application record 300A of FIG. 3A) and update existing application records based on data retrieved from the data source(s) 120. Although not illustrated in FIG. 1, the search system 100 may include modules that generate new application records and update existing application records based on the data retrieved from the data source(s) 120. In some examples, some data included in the application data store 108 is manually generated.

The data source(s) 120 may include a variety of different data providers. The data source(s) 120 may include data from application developers, such as application developers' websites. The data source(s) 120 may include operators of digital distribution platforms configured to distribute applications to the user device(s) 104. The data source(s) 120 may also include other websites, such as websites that include web logs (i.e., blogs), application review websites, or other websites including data related to applications. Additionally, the data source(s) 120 may include social networking sites, such as “FACEBOOK®” by Facebook, Inc. (e.g., Facebook posts) and “TWITTER®” by Twitter Inc. (e.g., text from tweets). The data source(s) 120 may also include additional types of data sources in addition to the data sources described above. Different data sources may have their own content and update rate.

The search system 100 and the similarity system 500 may retrieve data from one or more of the data source(s) 120. The data retrieved from the data source(s) 120 can include any type of data related to applications. Examples of data related to applications include, but are not limited to, a name of an application, a description of an application, a substantive review of an applications, a quality rating of an application, a developer name, an excerpt from a blog post about an application, a tweet about an application, user reviews or comments about an application, metadata fields of an application, and one or more images (e.g., icons and/or screenshots) associated with the application. The search system 100 and the similarity system 500 may also retrieve statistical data from the data source(s) 120. The statistical data may include any numerical data related to an application, such as a number of downloads, download rates (e.g., downloads per month), a number of reviews, and a number of ratings. In some examples, data retrieved from the data source(s) 120 includes information regarding the functionalities of applications or user feedback about their (i.e., the users') experience using an application.

As described above, the user device(s) 104, the search system 100, the similarity system 500, and the data source(s) 120 may be in communication with one another via the network 106. The network 106 may include various types of networks, such as a wide area network (WAN) and/or the Internet. Although the network 106 may represent a long range network (e.g., Internet or WAN), in some implementations, the network 106 includes a shorter range network, such as a local area network (LAN). In one embodiment, the network 106 uses standard communications technologies and/or protocols. Thus, the network 106 can include links using technologies, such as Ethernet, Wireless Fidelity (WiFi) (e.g., 802.11), worldwide interoperability for microwave access (WiMAX), 3G, Long Term Evolution (LTE), digital subscriber line (DSL), asynchronous transfer mode (ATM), InfiniBand, PCI Express Advanced Switching, etc. Similarly, the networking protocols used on the network 106 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 106 can be represented using technologies and/or formats including the hypertext markup language (HTML), the extensible markup language (XML), etc. In addition, all or some of the links can be encrypted using conventional encryption technologies, such as secure sockets layer (SSL), transport layer security (TLS), virtual private networks (VPNs), Internet Protocol security (IPsec), etc. In other examples, the network 106 can use custom and/or dedicated data communications technologies instead of, or in addition to, the ones described above.

FIG. 2 illustrates an example application search module 110 which may be included in the search system 100. The application search module 110 includes a query analysis module 202, an application set generation module 204 (hereinafter, “set generation module 204”), and an application set processing module (hereinafter, “set processing module 206”). The query analysis module 202 analyzes a received search query 200. For example, the query analysis module 202 may perform one or more of tokenization, filtering, stemming, synonymization, and stop word removal with respect to the search query 200. The set generation module 204 identifies a set of one or more applications based on the received (e.g., analyzed) search query 200. For example, the set generation module 204 may identify one or more application records included in the application data store 108 based on the received search query 200 and determine the applications based on the identified application records. In some examples, the identified application records each reference one of the applications using an application identifier (ID) associated with the application. In any case, the identified set of applications may be referred to herein as a “consideration set.” The set processing module 206 processes (e.g., scores) the consideration set to generate a set of one or more preliminary results 210. The preliminary result(s) 210 may include a list of one or more applications along with corresponding one or more result scores that each indicate a relative rank of one of the applications in the list.

As described herein, the application data store 108 includes data related to one or more different applications. The data associated with an application may be referred to herein as an “application record” (e.g., the application record 300A of FIG. 3A). Accordingly, the application data store 108 may include one or more different application records that each includes data related to a different application.

Referring now to FIGS. 3A and 3B, an example application record 300A includes an application name 302A, an application identifier (hereafter, “application ID”) 304A, and application attributes 306A. The application record 300A may generally represent data stored in the application data store 108 that is related to an application. The application data store 108 may include one or more application records each having a similar structure as that of the application record 300A. Put another way, the application data store 108 may include one or more application records each having an application name, an application ID, and application attributes.

The application name 302A may be a name of the application represented by the data included in the application record 300A. Examples of the application name 302A include “GOOGLE MAPS” by Google Inc., “FACEBOOK” by Facebook, Inc., “TWITTER®” by Twitter Inc., and “ANGRY BIRDS®” by Rovio Entertainment Limited. The application ID 304, 304A, 304B identifies the application record 300A among the other application records included in the application data store 108. For example, the application ID 304A may uniquely identify the application record 300A. The application ID 304A may be a string of alphabetic, numeric, and/or symbolic characters (e.g., punctuation marks) that uniquely identify the application record 300A.

The application attributes 306A may include any type of data, which may be associated with the application represented by the application record 300A. The application attributes 306A may include a variety of different types of data. For example, the application attributes 306A may include structured, semi-structured, and/or unstructured data. The application attributes 306A may include information that is extracted or inferred from documents retrieved from the data source(s) 120. In some examples, the application attributes 306A include data that is manually generated. The application attributes 306A may be updated so that up-to-date search results can be provided in response to a user's search query 200.

The application attributes 306A may include a name of a developer of the application, a publisher of the application, a category (e.g., genre) of the application, a description of the application (e.g., a developer's description), a version of the application, an operating system associated with the application, and a price of the application. The application attributes 306A may also indicate security or privacy data about the application, battery usage of the application, and bandwidth usage of the application.

Additionally, the application attributes 306A may include information that describes or otherwise indicates one or more of the following: one or more functions associated with the application, one or more internal states of the application, data used or provided by the application, a release date and/or an age of the application, and trustworthiness of the application.

The application attributes 306A may also include application statistics. The application statistics may refer to numerical data related to the application. For example, the application statistics may include, but are not limited to, a number of downloads, a download rate (e.g., downloads per month), a number of ratings, and a number of reviews. The application attributes 306A may also include information retrieved from websites, such as reviews associated with the application, articles associated with the application (e.g., wiki articles), or other information. The application attributes 306A may also include digital media related to the application, such as images (e.g., icons and/or screenshots).

FIG. 3B illustrates an example application record 300B for the application (e.g., a game) named “ANGRY BIRDS®” by Rovio Entertainment Limited. The application record 300B includes an application name “ANGRY BIRDS” indicated at 302B. The application record 300B also includes an application ID number indicated at 304B. The application record 300B further includes application attributes 306B. The application attributes 306B include data fields for a name of a developer and a genre of the ANGRY BIRDS® application. The developer of the application included in the application attributes 306B may be “Rovio Entertainment Limited.” The genre of the application may be “games.” The application attributes 306B may also include fields for a description and reviews associated with the ANGRY BIRDS® application. The description may include text that describes the ANGRY BIRDS® application. In some examples, the description is provided by the developer of the application. The field for the reviews includes text from user reviews of the application in some examples.

The application attributes 306B also include fields for application statistics, such as ratings and a number of downloads. The ratings field may indicate the ratings given to the application by users. For example, the ratings may include a number of stars (e.g., 0-5 stars) assigned to the application by the users. The number of downloads may indicate a total number of times the application has been downloaded.

Referring back to FIG. 2, the application search module 110 utilizes the search query 200 to perform an application search of the application data store 108. The query analysis module 202 receives the search query 200. The query analysis module 202 may perform various analysis operations on the received search query 200. For example, the analysis operations performed by the query analysis module 202 with respect to the search query 200 may include any of tokenization, filtering, stemming, synonymization, and stop word removal.

The search query 200 may be a query entered by a user on a user device 104. The search query 200 may include text, numbers, and/or symbols (e.g., punctuation) entered into the user device 104 by the user. For example, the user may have entered the search query 200 into a search field (e.g., a search box) of an application running on the user device 104 using a touchscreen keypad, a mechanical keypad, and/or via speech recognition. In some examples, the user device 104 transmits additional data along with the search query 200. The search query 200 and the additional data may be referred to as a query wrapper. The query wrapper may include information associated with the search query 200, such as platform constraint information (e.g., a device type, an operating system version, and a web-browser version associated with the user device 104), geo-location information associated with the user device 104, partner specific information, and other information. The search system 100 and the similarity system 500 receive the query wrapper in some examples. The search system 100 and the similarity system 500 may use the additional information included in the query wrapper to generate search results and identify similar applications (i.e., generate a similarity set).

The set generation module 204 identifies a set of one or more applications (i.e., the consideration set) based on the search query 200. In some examples, the set generation module 204 identifies the set of applications by identifying one or more application records included in the application data store 108 that reference the applications based on matches between terms of the search query 200 and terms included in the identified application records. For example, the set generation module 204 may identify the application records based on matches between tokens generated by the query analysis module 202 and words included in the application records. The consideration set of applications is a list of the identified application records in some examples. For example, the consideration set may be a list of one or more application IDs and/or a list of one or more application names associated with the application records (e.g., associated with the applications referenced in the application records).

The set processing module 206 performs a variety of different processing operations on the consideration set to generate a set of one or more ranked preliminary results 210 that includes a list of one or more applications and indications of their corresponding rank relative to one another (e.g., one or more result scores). In some implementations, the set processing module 206 generates a result score for each of the applications included in the consideration set in order to generate the preliminary results 210. In these implementations, the preliminary results 210 may include a list of one or more applications (e.g., one or more application IDs and/or one or more application names that reference the applications), each of which is associated with a corresponding result score. In some examples, the preliminary results 210 include all of the applications from the consideration set. In other examples, the preliminary results 210 may include a subset (i.e., some, but not all) of the applications from the consideration set. For example, the subset may include those applications of the consideration set that have the largest one or more result scores, or that have result scores that are higher than a dynamic or pre-defined (e.g., static) result score threshold.

The information conveyed by the preliminary results 210 may depend on how the result scores are calculated for the applications included in the consideration set by the set processing module 206. For example, the result scores may indicate relevance of the applications to the search query 200, popularity of the applications, quality of the applications, or other properties of the applications, depending on what parameters the set processing module 206 uses to score the applications of the consideration set.

The set processing module 206 may generate result scores for applications included in the consideration set in a variety of different ways. In general, the set processing module 206 may generate a result score for an application of the consideration set based on one or more scoring features. The scoring features may be associated with the application and/or the search query 200. An application scoring feature may include any data associated with an application. For example, application scoring features may include any of the application attributes included in an application record, or any additional parameters related to an application, such as data indicating popularity of the application (e.g., a number of downloads) and ratings (e.g., a number of stars) associated with the application. A query scoring feature may include any data associated with the search query 200. For example, query scoring features may include, but are not limited to, a number of words in the search query 200, popularity of the search query 200, and an expected frequency of words in the search query 200. An application-query scoring feature may include any data, which may be generated based on data associated with both an application and the search query 200 that resulted in identification of an application record associated with the application by the set generation module 204. For example, application-query scoring features may include, but are not limited, parameters that indicate how well terms of the search query 200 match terms of an identified application record. The set processing module 206 may generate a result score for an application of the consideration set based on at least one of the application scoring features, the query scoring features, and the application-query scoring features.

The set processing module 206 may determine a result score for an application of the consideration set based on one or more of the scoring features listed herein and/or any additional scoring features not explicitly listed. In some examples, the set processing module 206 includes one or more machine-learned models (e.g., a supervised learning model) configured to receive one or more of the scoring features. The one or more machine-learned models may generate result scores for applications of the consideration set based on at least one of the application scoring features, the query scoring features, and the application-query scoring features described above. For example, the set processing module 206 may pair the search query 200 with each application of the consideration set and calculate a vector of features for each (query, application) pair. The vector of features may include one or more application scoring features, query scoring features, and/or application-query scoring features. The set processing module 206 may then input the vector of features into a machine-learned regression model to calculate a result score for the application that may be used to rank the application among other applications included in consideration set and/or other applications included in the preliminary results 210.

The result scores generated for the applications included in the consideration set may be used in a variety of different ways. In some examples, the result scores rank the applications within a list of search results that is presented on a user device 104. In these examples, a larger result score may indicate that the corresponding application is more relevant to a user (e.g., the user's search query 200) than an application having a smaller result score. In examples where the search results are displayed as a list on a user device 104, applications associated with larger result scores may be listed nearer to the top of the list (e.g., near to the top of the screen of the user device 104). In these examples, applications having lower result scores may be located farther down the list (e.g., off screen) and may be accessed by a user scrolling down the screen of the user device 104.

The set of preliminary results 210 may be transmitted to the user device 104 that generated the search query 200 upon which the preliminary results 210 are based. Additionally, or alternatively, the set of preliminary results 210 may be transmitted to the similarity system 500. The preliminary results 210 may be formatted on the user device 104 as a list of applications, as described herein. The preliminary results 210 may include any information corresponding to the one or more applications included in the preliminary results 210. For example, the preliminary results 210 provided by the search system 100 to the user device 104 may be formatted as a list of applications, including, for example, a name of each application, an image associated with the application (e.g., an icon, a screenshot, and/or a video), a link to download the application, a description and rating of the application, and/or other information. The preliminary results 210 may also be formatted in a manner that can be interpreted by the similarity system 500. For example, the preliminary results 210 may be organized as a list of ranked application IDs.

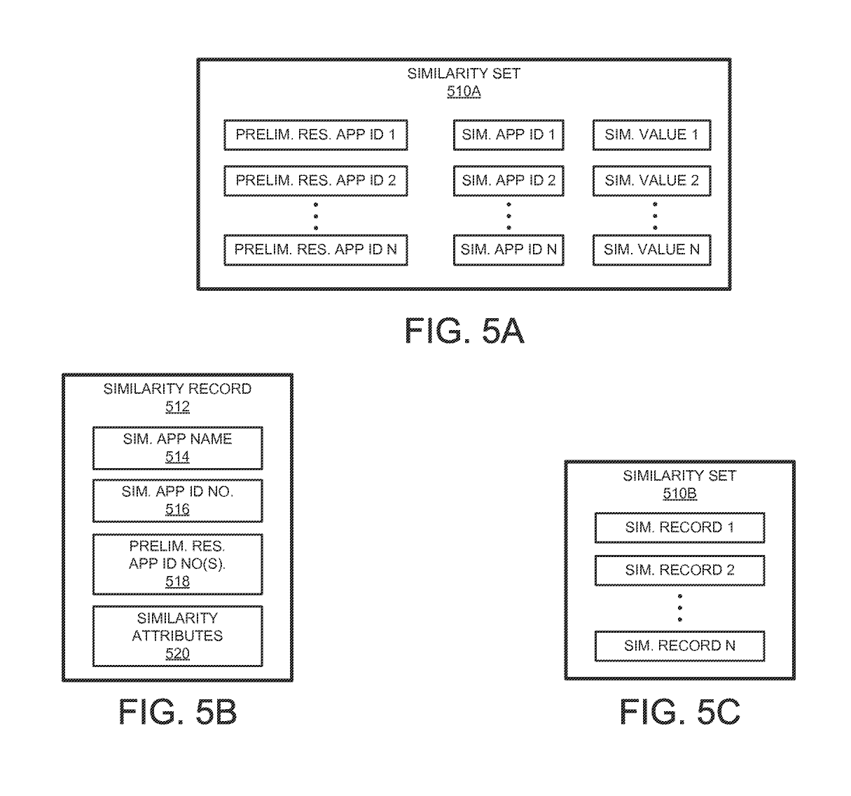

FIG. 4 illustrates an example method 400 for performing a search based on a received search query 200. The method 400 is described with reference to the application search module 110 of FIG. 1 and the various components thereof. In block 402, the application search module 110 receives a search query 200. In block 404, the query analysis module 202 analyzes (i.e., performs an analysis of) the search query 200, as described herein. In block 406, the set generation module 204 identifies a consideration set of applications (e.g., a set of application records) based on the search query 200 (e.g., based on an output of the query analysis module 202). In block 408, the set processing module 206 processes the consideration set of applications. For example, the set processing module 206 may generate a result score for each of the applications in the consideration set. In block 410, the set processing module 206 generates a set of preliminary results 210. The preliminary results 210 may include a list of applications and associated result scores. The search system 100 may then transmit the preliminary results 210 to the similarity system 500 and/or a user device 104.

FIGS. 5-6 illustrate operation of an example similarity system 500. The similarity system 500 contains a similarity module 502 and a similarity data store 504. The similarity system 500 can receive a set of preliminary results 210 containing application IDs, application names, or other indicators corresponding to applications uncovered by the search system 100 based on a user's search query 200. The similarity system 500 is further configured to transmit a similarity set identifying applications that are similar to the applications indicated by the preliminary results 210 to the search system 100. In some examples, the similarity set is a data structure that indicates one or more similar applications for each application in the preliminary results 210. In other examples, the similarity set indicates one or more similar applications for each of a subset of the applications included in the preliminary results 210 (e.g., the top twenty applications of the preliminary results 210 as indicated by the result scores associated with the applications).

In some implementations, the similarity module 502 determines a similarity score for two applications. In these implementations, the similarity module 502 can store the similarity score for the two applications in the similarity data store 504. A similarity score is a numerical value that indicates a degree of similarity between two different applications. In some implementations, the similarity score is a value from 0.0 to 1.0. In some examples, the similarity module 502 determines that two applications are similar when the similarity score for the two applications is greater than a threshold similarity score. In these examples, the similarity module 502 may determine that the two applications are dissimilar (i.e., not similar to one another) when the similarity score is less than the threshold similarity score. In some implementations, a similarity set indicates one or more applications that each surpass a similarity threshold (e.g., a threshold similarity score) with respect to an application received by the similarity system 500 from the search system 100 (i.e., an application included in a set or subset of the preliminary search results 210).

The similarity module 502 may determine a similarity score for two applications in a variety of manners. In some implementations, the similarity module 502 determines the similarity score for the two applications based on text matches between application records associated with the two applications. In other implementations, the similarity module 502 may determine the similarity score for the two applications based on whether the two applications are included in the same category (e.g., within a common genre) or contain similar keywords as defined in the respective applications' metadata. In still other implementations, the similarity module 502 may determine the similarity score for the two applications based on click data associated with the two applications. Click data associated with multiple applications is described in greater detail below. In some implementations, the similarity module 502 determines the similarity score for the two applications based on any combination of text matches between the corresponding application records, the categories of the applications (e.g., as specified by the application records), click data associated with the applications, and any other types of data associated with the applications and/or their corresponding application records.

As described herein, the similarity module 502 may determine whether the two applications are similar based on the data included in the application records associated with the two applications. For example, the similarity module 502 may determine a similarity score for the two applications based on the data included in the application records for the two applications. In some implementations, the similarity module 502 determines the similarity score for the two applications based on matches between categories of the applications (e.g., as indicated by the data included in the application records). In some examples, the similarity module 502 generates a larger similarity score (e.g., closer to 1.0) for two applications when the two applications are included in the same one or more categories.

In some implementations, the similarity module 502 determines the similarity score for the two applications based on text matches between the data included in the application records of the two applications. For example, the similarity module 502 may detect text matches between application attributes stored in the application records, including, but not limited to, a developer of an application, a publisher of the application, a description of the application (e.g., a developer's description), information retrieved from websites (e.g., reviews) associated with the application, articles associated with the application (e.g., wiki articles), or other information. In some examples, a greater number of text matches tend to yield a larger similarity score (e.g., closer to 1.0).

In some implementations, the similarity module 502 determines the similarity score for the two applications based on matches between other types of data included in the application records of the two applications. For example, the similarity module 502 may determine the similarity score based on data including, but not limited to, operating systems associated with the applications, prices of the applications, security or privacy data associated with the applications, battery usage of the applications, bandwidth usage of the applications, and application statistics associated with the applications. The similarity module 502 may also determine the similarity score based on functions associated with the applications, internal states of the applications, data used or provided by the applications, online source data related to the applications, release dates and/or ages of the applications, and trustworthiness of the applications.

Additionally, as also described herein, the similarity module 502 may determine the similarity score for the two applications based on click data for the two applications. As one example, a user selecting each of the two applications in a particular setting (e.g., from search results responsive to the user's search query 200, or from a list of applications grouped based on category) may result in a larger similarity score (e.g., 1.0) for the applications. In contrast, a user not selecting each of the two applications in the same or similar setting may result in a smaller similarity score (e.g., closer to 0.0) for the applications. As another example, a greater number of times that a user has selected the two applications in such a setting may result in a relatively larger similarity score (e.g., closer to 1.0) for the applications.

In some examples, the similarity module 502 determines the similarity score for the two applications based on a similarity matrix that includes a similarity score for each of one or more pairs of applications. In these examples, the one or more pairs of applications may correspond to pairwise groupings of some or all applications included in the application data store 108. As described previously, the similarity system 500 may access the application data store 108 to construct or update the similarity data store 504. Thus, if the application data store 108 includes N applications, the similarity matrix stored in the similarity data store 504 may be an N×N matrix that includes N*N, or N² similarity scores, with one similarity score associated with each pairwise grouping of the N applications. In some implementations, the similarity matrix stored in the similarity data store 504 is an N×M matrix (e.g., a reduced version of the N×N matrix described above), where M is less than N. In some examples, M corresponds to a number (e.g., a subset) of the N applications that are each most similar to another one of the N applications (e.g., the two applications may have a similarity score that is above a similarity threshold). In other words, in these examples, the similarity matrix may be reduced from the N×N matrix to the N×M matrix by omitting one or more of the N applications from either the row or the column of the N×N matrix (e.g., in situations where the similarity matrix only includes pairs of applications that have a similarity score that is above a certain similarity threshold). As previously explained, the similarity score for the two applications of each pair of applications indicates a degree of similarity between the two applications. For a pairwise grouping of a particular application within the similarity data store 504 with itself, the similarity score included in the similarity matrix may be 1.0, indicating that the two applications of the corresponding pair of applications are the same. Alternatively, in other examples, similarity scores for pairwise groupings of the same application may be omitted from the similarity matrix.

In the examples described above, each similarity score included in the similarity matrix represents a quantitative measure of how similar a given application is to another application. The similarity scores can be calculated in any suitable manner. In some implementations, each similarity score for two applications is calculated based on one or more of 1) a latent semantic indexing (LSI) cosine-similarity value for the applications, 2) a text similarity value (e.g., based on text matches between the corresponding application records) for the applications, and 3) importance value (e.g., based on numbers of downloads and/or average rating values) for the applications, as well as based on any number of additional or alternative attributes of the applications. Additionally, heuristic and natural language processing techniques may be applied to determine the attributes that are used to determine the similarity scores for the applications. In some examples, the similarity matrix described above can be calculated offline and updated in any suitable manner.

To determine a similarity score for a first application and a second application (i.e., to determine whether, and to what degree, the two applications are similar) using the similarity matrix, the similarity module 502 may identify a location (e.g., a row and a column) in the similarity matrix that corresponds to the pairwise grouping of the two applications and extract the similarity score included therein. The similarity module 502 can repeat this process for pairwise groupings of the first application with other applications to determine the corresponding similarity score. For each extracted similarity score, the similarity module 502 may compare the similarity score to a corresponding threshold similarity score to determine whether the two applications associated with the similarity score are similar. In this manner, the similarity module 502 may compare an application included in the preliminary results 210 with an application included in the application data store 108 and/or an application included in the similarity data store 504 to determine whether the application included in the preliminary results 210 is similar to any of the other applications. As described herein, the similarity module 502 may perform such a determination for each of one or more applications of the preliminary results 210 to generate the similarity set.

Specifically, to generate the similarity set, the similarity module 502 can use as inputs one or more of the applications indicated by (or included in) the preliminary results 210. For each application indicated by (or included in) the preliminary results 210, the similarity module 502 determines whether there are any similar applications in the application data store 108 and/or the similarity data store 504. As described herein, this process may entail generating and/or retrieving a similarity score associated with the application of the preliminary results 210 and another application included in the application data store 108 and/or the similarity data store 504, and comparing the similarity score against a similarity threshold (e.g., a threshold similarity score). The similarity module 502 may include applications located in the application data store 108 and/or the similarity data store 504 and associated with similarity scores higher than the similarity threshold of the similarity set. The similarity threshold can be a hard-coded or a dynamically-generated value (e.g., 0.7). In some examples, the similarity data store 504 includes a similarity lookup table (e.g., a so-called “LUT”) that may increase the speed of determining a similarity score in the manner described above. The similarity lookup table may include similarity scores for different pairs of applications. For example, the similarity lookup table includes a similarity score for all possible pairs of applications in some examples. In general, the similarity lookup table may include any type of information that indicates similarity among two or more applications (i.e., without necessarily using similarity scores). In any case, the similarity module 502 may update the similarity lookup table over time as applications are added and removed from digital distribution platforms. The similarity module 502 may also update the similarity lookup table over time as modifications are made to applications, which may be reflected in the corresponding application records. At search time (e.g., upon a user device 104 submitting a search query 200 to the search system 100), the similarity system 500 (e.g., the similarity module 502) may quickly generate the similarity set by identifying one or more applications included in the application data store 108 and/or the similarity data store 504 that are each similar to an application included in the preliminary results 210 using the similarity lookup table.

In some embodiments, the similarity module 502 can generate the similarity set to include one or more application IDs of the similar applications (e.g., the applications that surpass the specified similarity threshold). In these embodiments, the similarity module 502 may organize the similarity set in the form of a list, wherein each element of the list is an application ID of an application that is similar to an application in the preliminary results 210. In scenarios where one application is similar to several applications in the preliminary results 210, an application ID of the similar application may appear several times in the similarity set. In some embodiments, the similarity module 502 can organize the similarity set in the form of a table that uses the application IDs of the applications of the preliminary results 210 as indices, and the application IDs and similarity scores of the similar applications as values at those indices (e.g., as shown in the similarity set 510A depicted in FIG. 5A). In still other examples, the data stored in the similarity set may be organized in the form of one or more similarity records (e.g., the similarity record 512 and the similarity set 510B that includes multiple similarity records depicted in FIGS. 5B and 5C, respectively). In these examples, a similarity record 512 may contain a name 514 of a similar application, an application ID (or ID number) 516 of the similar application, and similarity attributes 520 of the similar application. Also in these examples, the similarity record 512 (e.g., the similarity attributes 520) may further contain one or more application IDs (or ID numbers) 518 of applications included in the preliminary results 210 to which the similar application is similar, one or more similarity scores each associated with the similar application and one of the applications included in the preliminary results 210, and/or any other suitable data pertaining to the relationships between the similar application and the applications included in the preliminary results 210.

FIG. 6 illustrates an example modification module 112 that receives a similarity set 510 from the similarity system 500 and a set of preliminary results 210 from the application search module 110. The modification module 112 is configured to modify the preliminary results 210 based on the similarity set 510. In some examples, the modification module 112 can insert new applications from the similarity set 510 into the preliminary results 210 to generate search results 600. Additionally, or alternatively, the modification module 112 can promote the rank of one or more applications each appearing in both the preliminary results 210 and the similarity set 510 to generate the search results 600. Modifying the preliminary results 210 transforms the preliminary results 210 into a modified result set 602, as shown in FIG. 6.

In some implementations, the modification module 112 can modify the preliminary results 210 by first assigning a boost score to each application indicated by (or included in) the similarity set 510. In some examples, a similar application (e.g., the application referenced by the similarity record 512 depicted in FIG. 5B) included in the similarity set 510 appears several times in the similarity set 510 (e.g., a similarity set 510 organized in the form of a list, or a similarity set 510 organized in the form of a table that uses applications of the preliminary results 210 as indices and one or more similar applications and/or corresponding similarity scores as values at those indices). In these examples, every instance of the similar application may receive a uniform (e.g., same) boost score. For example, if the similar application is associated with several applications of the preliminary results 210 and several similarity scores, it may still receive only one boost score for purposes of the modification techniques described herein. In other examples, the similarity set 510 may be organized using similarity records, such as the similarity record 512 and the similarity set 510B including multiple similarity records illustrated in FIGS. 5B and 5C. In these examples, each similarity record may be assigned its own boost score. In this way, each similarity record receives a boost score corresponding to the similar application that the similarity record represents. In either example, to generate the modified result set 602, the modification module 112 may selectively insert a similar application of the similarity set 510 into the preliminary results 210, or increase a rank of the application within the preliminary results 210, based on a boost score associated with the similar application.

In some examples, the boost score associated with the similar application can be calculated based on the set, or a subset, of the preliminary results 210 (e.g., the top twenty applications of the preliminary results 210) to which the similar application is similar. For example, the boost score can be based on a total number of applications of the preliminary results 210 that are associated with (e.g., similar to) the similar application. Additionally, or alternatively, the boost score can be based on a degree of relevance to the search query 200 that is represented by the applications of the preliminary results 210 associated with the similar application. In some examples, the boost score can be based on calculations made using the one or more similarity scores associated with the similar application (e.g., an average, or median, of the similarity scores).

In some implementations, the modification module 112 filters applications indicated by the similarity set 510 from being used to modify the preliminary results 210 based on a threshold boost score. The threshold boost score can be a hard-coded or dynamically generated value (e.g., 0.8). The similar applications in the similarity set 510 that do not surpass the boost threshold (i.e., the threshold boost score) are not considered for purposes of modification. For example, similar applications with boost scores below the boost threshold will not have their rank promoted in the preliminary results 210, nor be inserted into the preliminary results 210, to generate the modified result set 602.

In some embodiments, the modification module 112 categorizes the similar applications such that they fall into one of three categories, whereby each category determines the type of modification the modification module 112 will execute with regard to similar applications in that category. For example, a first category of the similar applications can be those similar applications that were previously ranked and included in the preliminary results 210 by the application search module 110 (i.e., applications identified by the similarity system 500 that have already been included in the preliminary results 210). In some examples, the modification module 112 can promote similar applications in the first category of the similar applications to higher ranks in the preliminary results 210 to generate the modified result set 602. The modification module 112 can promote similar applications in the first category of the similar applications based on their boost score. For example, the modification module 112 can add a boost score associated with one such similar application to a result score of an application of the preliminary results 210 that corresponds to the similar application, thus yielding a higher overall result score (and, therefore, rank) for that application in the preliminary results 210, and thus in the modified result set 602. Additionally, or alternatively, the modification module 112 can employ any other suitable calculations to determine a new rank of an application of the preliminary results 210 in the modified result set 602. For example, the modification module 112 can determine the new rank by performing calculations using other information including, but not limited to, an importance of the application, relevance of the application to the search query 200, and/or one or more similarity scores associated with the application (e.g., associated with one or more applications that are similar to the application of the preliminary results 210, as specified by the similarity set 510).

In some embodiments, a second category of the similar applications can include similar applications that do not appear in the preliminary results 210. In these examples, the modification module 112 may insert each such similar application into the preliminary results 210 at a specified rank to generate the modified result set 602. The modification module 112 can determine the rank at which to insert each such similar application using the similar application's boost score, importance, and/or any other suitable value. For example, the modification module 112 may add the similar application's boost score to a value indicative of the application's relevance. In other examples, the modification module 112 may insert the similar application immediately below an application of the preliminary results 210 with the closest importance value higher than its own (e.g., if the similar application has an importance value of 0.77, it may be ranked immediately below an application with an importance value of 0.78).

In some implementations, a third category of the similar applications can include similar applications whose boost scores exceed the boost threshold, but which will not be included in the modified result set 602. These similar applications may be excluded from the modified result set 602 by the modification module 112 for several reasons. In some examples, the similar applications do not satisfy a relevance, importance, or popularity threshold. In other examples, the similar applications may be outdated. In some examples, the similar applications do not run on a specified operating system. In still other examples, the similar applications may lack the intent specified by the search query 200. The modification module 112 may exclude such similar applications from the modified result set 602 based on any of the previously described examples, or for any other suitable reason.

FIG. 6 further illustrates an example results generation module 114. The results generation module 114 is configured to receive a modified result set 602 and/or a set of preliminary results 210 from the modification module 112. The results generation module 114 is further configured to transform the modified result set 602 and/or the set of preliminary results 210 into search results 600 that can be rendered and displayed on a user device 104 and/or any other suitable computing device. In some examples, the results generation module 114 is configured to generate computer-readable instructions that cause a computing device to display the search results 600 using a GUI in the manner described above.

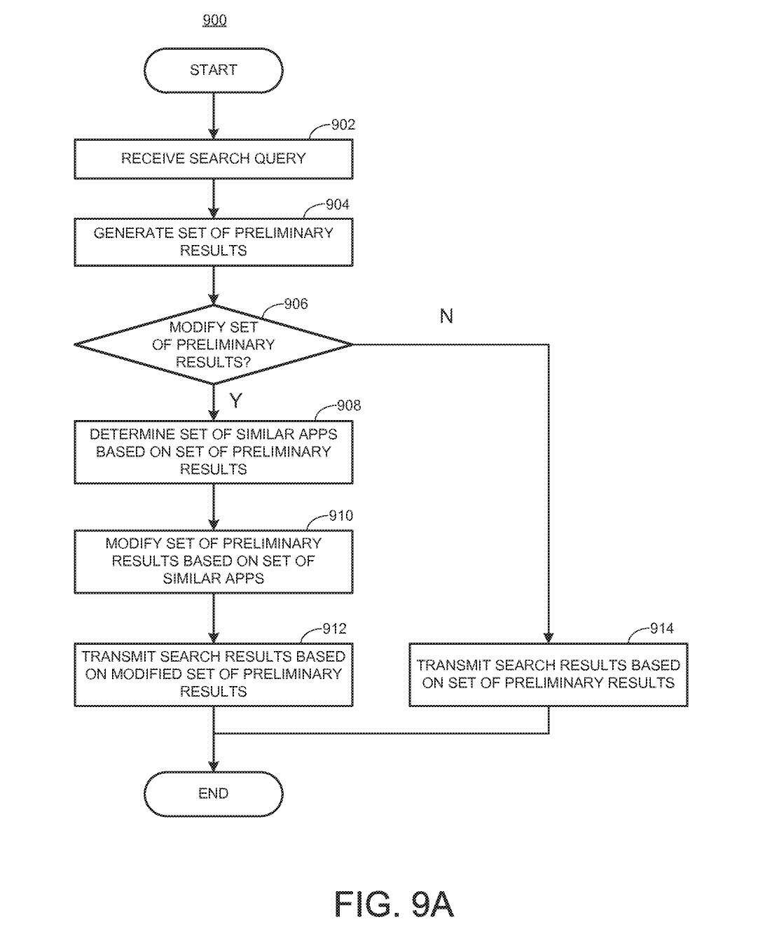

FIG. 7 shows an example set of operations of a method 700 for providing search results 600 that benefit from the modification techniques described herein. The search results 600 may be generated based on a received search query 200. For purposes of explanation, the method 700 is described with respect to the components of the search system 100 and the similarity system 500.

At operation 702, the search system 100 receives a search query 200 from a user device 104 or other suitable computing device. The search query 200 may be received in a query wrapper. The requesting user device 104 may include any other suitable information in the query wrapper.

At operation 704, the application search module 110 identifies, or generates, a set of preliminary results 210 based on the search query 200. Specifically, the application search module 110 utilizes the search query 200 to identify a set of preliminary results 210 containing application IDs and result scores (or any other suitable ranking values) for applications that satisfy the search query 200, as described herein. In some implementations, the application search module 110 identifies the applications indicated by (or included in) the preliminary results 210 using the application records included in the application data store 108, as also described herein.

At operation 706, the similarity module 502 determines a set of similar applications based on the set of preliminary results 210. In other words, the similarity module 502 receives the set of preliminary results 210 generated by the application search module 110. The similarity module 502 further identifies (e.g., retrieves), or generates, a similarity set 510 of applications that are each similar to an application indicated by (or included in) the preliminary results 210. In some implementations, the similarity module 502 identifies the similar applications using the application records included in the application data store 108, the similarity records included in the similarity data store 504, and/or other data structures or techniques described herein (e.g., a similarity matrix, or a similarity look up table). For example, the similarity module 502 may determine whether any two applications are similar using a similarity score associated with the two applications that is available in the similarity data store 504. In some implementations, the similarity module 502 includes applications in the similarity set 510 based on whether similarity scores of the applications surpass a specified similarity threshold, as described herein.

At operation 708, the modification module 112 modifies the set of preliminary results 210 based on the set of similar apps. In other words, the modification module 112 receives the similarity set 510 and the preliminary results 210 and modifies the preliminary results 210 based on the similarity set 510. The modification module 112 can assign each similar application included in the similarity set 510 a boost score based on a variety of data including, but not limited to, a similarity score, popularity, a total number of applications of the preliminary results 210 the similar application is similar to, or any other suitable data. The modification module 112 can also filter applications in the similarity set 510 based on a boost threshold (e.g., a threshold boost score). In other words, for purposes of modifying the preliminary results 210 using the similarity set 510, the modification module 112 may only consider applications of the similarity set 510 with boost scores higher than the boost threshold. The modification module 112 can further construct a modified result set 602 using applications of the similarity set 510 (e.g., to increase a rank of an application of the preliminary results 210, or to insert a new application into the preliminary results 210) with boost scores higher than the boost threshold. The modification module 112 can omit certain similar applications of the similarity set 510 from consideration for generating the modified result set 602 based on a set of pre-defined rules, such as whether or not those applications operate on a certain operating system. At operation 710, the results generation module 114 receives the modified result set 602 and uses it to generate and transmit search results 600.

As shown in FIG. 8, in some implementations of the techniques of the present disclosure, the search system 100 is equipped with a determination module 800 configured to determine whether to modify preliminary results 210 and/or whether the search system 100 returns search results 600 that are based on a modified result set 602 or based on a set of preliminary results 210. To make one or more of the above-described determinations, the determination module 800 may analyze or consider various data provided by, or otherwise associated with, the search system 100 and the similarity system 500 (though not explicitly pictured in FIG. 8, the determination module 800 is further configured to access the similarity system 500). As one example (e.g., at the first tier), the determination module 800 may analyze information provided by the application search module 110, such as a search query 200 and a set of preliminary results 210. As another example (e.g., at the second tier), the determination module 800 may analyze information provided by the modification module 112, such as a modified result set 602 and a similarity set 510. As still another example (e.g., at the third tier), the determination module 800 may analyze information provided by the results generation module 114, such as a set of search results 600 generated using a modified result set 602. In each of the above-described examples (i.e., at each tier), the determination module 800 can further analyze information available according to another one of the examples (e.g., at one or more previous tiers). For example, at the third tier, the determination module 800 may also analyze a search query 200, a set of preliminary results 210, a modified result set 602, and/or a similarity set 510 in addition to the search results 600 generated by the results generation module 114.

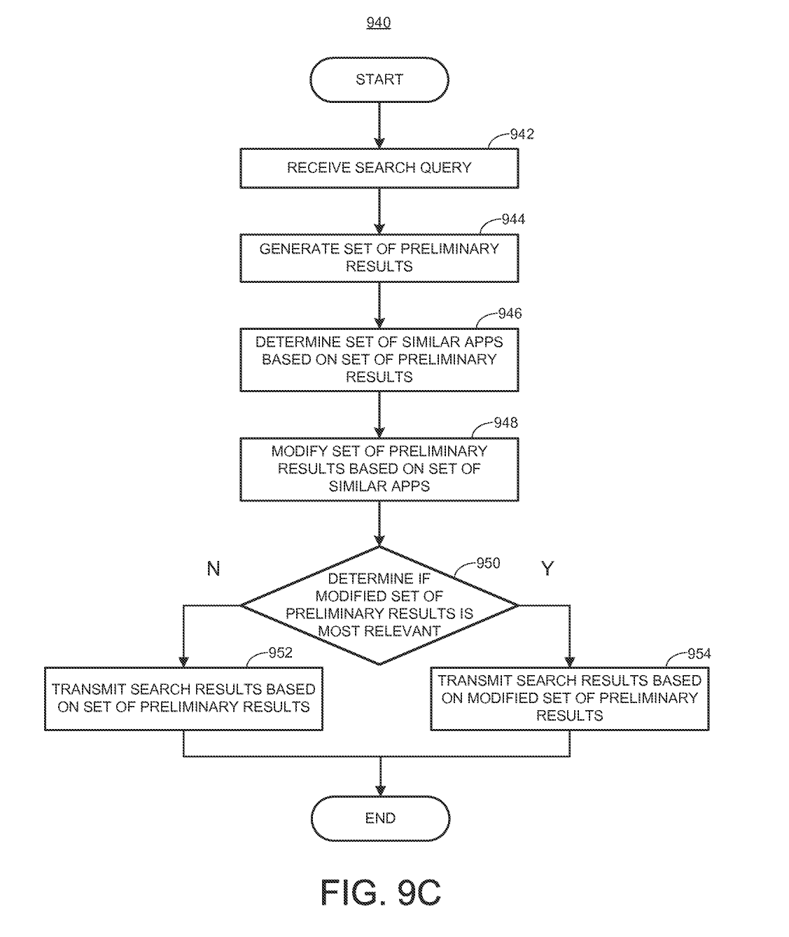

FIGS. 9A-9C show example sets of operations of methods for providing search results 600 using a determination module 800 at different tiers. Although these methods describe determination modules 800 at different tiers, this disclosure contemplates the use of any combination of determination modules 800 at any combination of tiers and/or a single determination module 800 that executes determination functions at every tier.

FIG. 9A illustrates an example set of operations of a method 900 for providing search results 600 using a determination module 800 that determines whether to modify a set or subset of preliminary results 210 based on a search query 200 and/or the set of preliminary results 210 (e.g., the first tier, as described above). For purposes of explanation, the method 900 is described with respect to the components of the search system 100 and the similarity system 500.

At operation 902, the search system 100 receives a search query 200 from a user device 104 or other suitable computing device. The search query 200 may be received in a query wrapper. The requesting user device 104 may include any other suitable information in the query wrapper.

At operation 904, the application search module 110 identifies, or generates, a set of preliminary results 210 based on the search query 200. As explained herein, the application search module 110 may use the search query 200 to identify a set of preliminary results 210 containing application IDs and result scores (or any other suitable ranking values) for applications that satisfy the search query 200. In some implementations, the application search module 110 identifies the applications indicated by the preliminary results 210 using the application records included in the application data store 108, as also explained herein.

At operation 906, the determination module 800 determines whether to modify the set of preliminary results 210. Specifically, the determination module 800 receives the set of preliminary results 210 generated by the application search module 110. Additionally, or alternatively, the determination module 800 receives the search query 200 received by the search system 100. The determination module 800 further analyzes the preliminary results 210 and/or the search query 200 to determine whether relevance of the preliminary results 210 can be enhanced by modifying the preliminary results 210 using the techniques disclosed herein. In some examples, the determination module 800 determines that modifying the preliminary results 210 is unlikely to enhance their relevance based on the nature of the search query 200. For example, the determination module 800 may reference a pre-defined list of one or more acceptable search queries 200 for which the preliminary results 210 should be modified. If the search query 200 does not appear on the pre-defined list, the determination module 800 can cause the application search module 110 to transmit the preliminary results 210 directly to the results modification module 112, thereby foregoing execution of the modification techniques described herein (e.g., as indicated at the “N” branch of operation 906, and at operation 914). In other examples, the determination module 800 may analyze the preliminary results 210 to determine whether to modify the preliminary results 210. In these examples, the determination module 800 may consider factors, such as one or more types of applications listed in the preliminary results 210, a number of applications listed in the preliminary results 210, whether the applications of the preliminary results 210 are sufficiently similar to one another, and/or any other suitable aspects of the preliminary results 210. In still other implementations, the determination module 800 may consider both the search query 200 and the preliminary results 210 to determine whether or not to modify the preliminary results 210. The factors the determination module 800 may consider in making this determination can include, but are not limited to, relevance of the preliminary results 210 to the search query 200, popularity of the search query 200, popularity of the applications in the preliminary results 210, and/or any other suitable qualities related to the search query 200 and/or the preliminary results 210. In scenarios where the determination module 800 instructs the search system 100 (e.g., the modification module 112) to modify the preliminary results 210 (i.e., the “Y” branch of operation 906), the method 900 proceeds to operation 908. In scenarios where the determination module 800 instructs the search system 100 to transmit search results 600 based on the preliminary results 210 without their modification (i.e., the “N” branch of operation 906), the method 900 proceeds to operation 914.

At operation 908, the similarity module 502 receives the set of preliminary results 210 generated by the application search module 110 and identifies, or generates, a similarity set 510 of applications that are similar to the applications indicated by (or included in) the preliminary results 210. In other words, at operation 908, the similarity module 502 determines a set of similar applications based on the set of preliminary results 210. In some implementations, the similarity module 502 identifies the similar applications using the application records included in the application data store 108, the similarity records included in the similarity data store 504, and/or other techniques or data structures described herein (e.g., a similarity matrix, or a similarity look up table). In some examples, the similarity module 502 determines whether two applications are similar using a similarity score associated with the two applications that is available in the similarity data store 504. In some implementations, the similarity module 502 includes a particular application in the similarity set 510 based on whether a similarity score associated with the application surpasses a specified similarity threshold (e.g., a threshold similarity score), as described herein.

At operation 910, the modification module 112 modifies the set of preliminary results 210 based on the set of similar applications (i.e., the similarity set 510). Specifically, the modification module 112 receives the similarity set 510 and the preliminary results 210. The modification module 112 can assign each application indicated by (or included in) the similarity set 510 a boost score based on a variety of data including, but not limited to, a corresponding similarity score, popularity, a total number of applications in the preliminary results 210 the application is similar to, or any other suitable data. The modification module 112 can also filter applications included in (or indicated by) the similarity set 510 based on a boost threshold (e.g., a threshold boost score). For example, for purposes of modifying the preliminary results 210, the modification module 112 may only consider applications in the similarity set 510 with boost scores higher than the boost threshold. The modification module 112 can further construct a modified result set 602 using one or more applications in the similarity set 510 (e.g., to increase a rank of an application of the preliminary results 210, or to insert a new application into the preliminary results 210) with boost scores higher than the boost threshold. The modification module 112 can omit certain similar applications of the similarity set 510 from being considered in constructing the modified result set 602 based on a set of pre-defined rules, such as whether or not those applications operate on a certain operating system.

At operation 912, the results generation module 114 receives the modified result set 602 and uses it to generate and transmit search results 600. Alternatively, as previously explained, at operation 914, the results generation module 114 receives the preliminary results 210 and uses them to generate and transmit the search results 600.

FIG. 9B illustrates an example set of operations of a method 920 for providing search results 600 using a determination module 800 that determines whether to modify a set or subset of preliminary results 210 based on a similarity set 510 and/or the set of preliminary results 210 (e.g., the second tier, as described above). For purposes of explanation, the method 920 is described with respect to the components of the search system 100 and the similarity system 500.

At operation 922, the search system 100 receives a search query 200 from a user device 104 or other suitable computing device. The search query 200 may be received in a query wrapper. The requesting user device 104 may include any other suitable information in the query wrapper.

At operation 924, the application search module 110 identifies, or generates, a set of preliminary results 210 based on the search query 200. As described herein, the application search module 110 may use the search query 200 to identify a set of preliminary results 210 containing application IDs and result scores (or any other suitable ranking values) for applications that satisfy the search query 200. In some implementations, the application search module 110 identifies the applications indicated by the preliminary results 210 using the application records in the application data store 108, as also described herein.

At operation 926, the similarity module 502 receives the set of preliminary results 210 generated by the application search module 110 and identifies, or generates, a similarity set 510 of applications that are similar to the applications indicated by (or included in) the preliminary results 210. In other words, at operation 926, the similarity module 502 determines a set of similar applications based on the set of preliminary results 210. In some implementations, the similarity module 502 identifies the similar applications using the application records included in the application data store 108, the similarity records included in the similarity data store 504, and/or other techniques or data structures described herein (e.g., a similarity matrix, or a similarity look up table). In some examples, the similarity module 502 determines whether two applications are similar using a similarity score associated with the two applications that is available in the similarity data store 504. In some implementations, the similarity module 502 includes a particular application in the similarity set 510 based on whether a similarity score associated with the application surpasses a specified similarity threshold (e.g., a threshold similarity score), as described herein.

At operation 928, the determination module 800 determines whether to modify the set of preliminary results 210. Specifically, the determination module 800 receives the similarity set 510 and/or the set of preliminary results 210. In some examples, to determine whether to modify the preliminary results 210, the determination module 800 is configured to determine or assess the quality of the similarity set 510. For example, the determination module 800 can make this determination or assessment based on a size of (e.g., a number of applications included in) the similarity set 510, relevance of the applications in the similarity set 510 to the search query 200, an average similarity score of the applications in the similarity set 510, or any other suitable factors. In examples where the determination module 800 determines, based on the quality of the similarity set 510 that the preliminary results 210 are unlikely to benefit from the modification techniques described herein, the determination module 800 can preclude the modification module 112 from transmitting a modified result set 602 to the results generation module 114 for generating search results 600. For example, the determination module 800 may prevent the modification module 112 from generating the modified result set 602 based on the preliminary results 210. Instead, in these examples, the determination module 800 may provide the results generation module 114 with the preliminary results 210 for generating the search results 600 (e.g., as indicated at the “N” branch of operation 928, and at operation 932). In this manner, the determination module 800 may cause the search system 100 to generate the search results 600 based on a search algorithm that does not use the modification techniques described herein. Alternatively, in examples where the determination module 800 determines, based on the quality of the similarity set 510 that the preliminary results 210 are likely to benefit from the modification techniques disclosed herein, the determination module 800 may allow the modification module 112 to transmit the modified result set 602 to the results generation module 114 for generating the search results 600 (e.g., as indicated at the “Y” branch of operation 928, and at operation 930). In these examples, the results generation module 114 may generate the search results 600 based on the modified result set 602, thereby providing search results 600 that leverage the modification techniques disclosed herein.

At operation 930, the modification module 112 modifies the set of preliminary results 210 based on the set of similar applications (i.e., the similarity set 510). Specifically, the modification module 112 receives the similarity set 510 and the preliminary results 210. The modification module 112 can assign each application indicated by (or included in) the similarity set 510 a boost score based on a variety of data including, but not limited to, a corresponding similarity score, popularity, a total number of applications in the preliminary results 210 the application is similar to, or any other suitable data. The modification module 112 can also filter applications included in (or indicated by) the similarity set 510 based on a boost threshold (e.g., a threshold boost score). For example, for purposes of modifying the preliminary results 210, the modification module 112 may only consider applications in the similarity set 510 with boost scores higher than the boost threshold. The modification module 112 can further construct a modified result set 602 using one or more applications in the similarity set 510 (e.g., to increase a rank of an application of the preliminary results 210, or to insert a new application into the preliminary results 210) with boost scores higher than the boost threshold. The modification module 112 can omit certain similar applications of the similarity set 510 from being considered in constructing the modified result set 602 based on a set of pre-defined rules, such as whether or not those applications operate on a certain operating system.

At operation 932, the results generation module 114 receives the modified result set 602 and uses it to generate and transmit search results 600. Alternatively, as previous explained, the results generation module 114 receives the preliminary results 210 and uses them to generate and transmit the search results 600.

FIG. 9C illustrates an example set of operations of a method 940 for providing search results 600 using a determination module 800 that determines whether to modify a set or subset of preliminary results 210 based on one or more of a search query 200, the set of preliminary results 210, a similarity set 510, and/or a modified result set 602 (e.g., the third tier, as described above). For purposes of explanation, the method 940 is described with respect to the components of the search system 100 and the similarity system 500.

At operation 942, the search system 100 receives a search query 200 from a user device 104 or other suitable computing device. The search query 200 may be received in a query wrapper. The requesting user device 104 may include any other suitable information in the query wrapper.

At operation 944, the application search module 110 identifies, or generates, a set of preliminary results 210 based on the search query 200. As described herein, the application search module 110 may use the search query 200 to identify a set of preliminary results 210 containing application IDs and result scores (or any other suitable ranking values) for applications that satisfy the search query 200. In some implementations, the application search module 110 identifies the applications indicated by the preliminary results 210 using the application records in the application data store 108, as also described herein.

At operation 946, the similarity module 502 receives the set of preliminary results 210 generated by the application search module 110 and identifies, or generates, a similarity set 510 of applications that are similar to the applications indicated by (or included in) the preliminary results 210. In other words, at operation 946, the similarity module 502 determines a set of similar applications based on the set of preliminary results 210. In some implementations, the similarity module 502 identifies the similar applications using the application records included in the application data store 108, the similarity records included in the similarity data store 504, and/or other techniques or data structures described herein (e.g., a similarity matrix, or a similarity look up table). In some examples, the similarity module 502 determines whether two applications are similar using a similarity score associated with the two applications that is available in the similarity data store 504. In some implementations, the similarity module 502 includes a particular application in the similarity set 510 based on whether a similarity score associated with the application surpasses a specified similarity threshold (e.g., a threshold similarity score), as described herein.

At operation 948, the modification module 112 modifies the set of preliminary results 210 based on the set of similar applications (i.e., the similarity set 510). Specifically, the modification module 112 receives the similarity set 510 and the preliminary results 210. The modification module 112 can assign each application indicated by (or included in) the similarity set 510 a boost score based on a variety of data including, but not limited to, a corresponding similarity score, popularity, a total number of applications in the preliminary results 210 the application is similar to, or any other suitable data. The modification module 112 can also filter applications included in (or indicated by) the similarity set 510 based on a boost threshold (e.g., a threshold boost score). For example, for purposes of modifying the preliminary results 210, the modification module 112 may only consider applications in the similarity set 510 with boost scores higher than the boost threshold. The modification module 112 can further construct a modified result set 602 using one or more applications in the similarity set 510 (e.g., to increase a rank of an application of the preliminary results 210, or to insert a new application into the preliminary results 210) with boost scores higher than the boost threshold. The modification module 112 can omit certain similar applications of the similarity set 510 from being considered in constructing the modified result set 602 based on a set of pre-defined rules, such as whether or not those applications operate on a certain operating system.

At operation 950, the determination module 800 determines whether the modified set of preliminary results 210 (i.e., the modified result set 602) is most relevant to the search query 200 (i.e., more relevant than the set of preliminary results 210). Specifically, the determination module 800 receives search results 600 that are generated by the results generation module 114 based on the modified result set 602. Additionally, or alternatively, the determination module 800 may receive the set of preliminary results 210, the similarity set 510, the modified result set 602, and/or the search query 200. The determination module 800 may be configured to determine whether the search system 100 transmits search results 600 that are based on the preliminary results 210, or search results 600 that are based on the modified result set 602. The determination module 800 may make this determination based on whether the modification techniques disclosed herein enhanced the relevance of the preliminary results 210. In these examples, the determination module 800 can take into consideration a number of applications of the preliminary results 210 promoted (i.e., increased in rank) within the preliminary results 210 by the modification module 112, a number of new applications inserted by the modification module 112 into the preliminary results 210 to construct the modified result set 602, relevance of the newly inserted or promoted applications to the search query 200, and/or any other suitable factors related to one or more of the modified result set 602, the similarity set 510, the search query 200, the set of preliminary results 210, and the relationships between them. In scenarios where the determination module 800 determines that the relevance of the preliminary results 210 was enhanced by the modification techniques described herein, the method 900 proceeds to operation 954. In scenarios where the determination module 800 determines that the relevance of the preliminary results 210 was not enhanced by modification, the method 900 proceeds to operation 952.

At operation 952, the results generation module 114 receives the set of preliminary results 210 and uses the set of preliminary results 210 to generate and transmit search results 600. Alternatively, as previously explained, at operation 954, the results generation module 114 receives the modified result set 602 and uses the modified result set 602 to generate and transmit the search results 600.

Modules and data stores included in the search system 100 and the similarity system 500 represent features that may be included in the search system 100 and the similarity system 500 of the present disclosure. For example, the application search module 110, the modification module 112, the results generation module 114, the determination module 800, the similarity module 502, the application data store 108, and the similarity data store 504 may represent features included in the search system 100 and the similarity system 500. The modules and data stores described herein may be embodied by electronic hardware, software, firmware, or any combination thereof. Depiction of different features as separate modules and data stores does not necessarily imply whether the modules and data stores are embodied by common or separate electronic hardware or software components. In some implementations, the features associated with one or more modules and data stores depicted herein are realized by common electronic hardware and software components. In some implementation, the features associated with the one or more modules and data stores depicted herein may be realized by separate electronic hardware and software components.

The modules and data stores may be embodied by electronic hardware and software components including, but not limited to, one or more processing units, one or more memory components, one or more input/output (I/O) components, and interconnect components. The interconnect components may be configured to provide communication between the one or more processing units, the one or more memory components, and the one or more I/O components. For example, the interconnect components may include one or more buses that are configured to transfer data between electronic components. The interconnect components may also include control circuits (e.g., a memory controller and/or an I/O controller) that are configured to control communication between electronic components.

The one or more processing units may include one or more central processing units (CPUs), graphics processing units (GPUs), digital signal processing units (DSPs), or other processing units. The one or more processing units may be configured to communicate with the one or more memory components and I/O components. For example, the one or more processing units may be configured to communicate with the one or more memory components and I/O components via the interconnect components.

A memory component, or memory, may include any volatile or non-volatile media. For example, the memory may include, but is not limited to, electrical media, magnetic media, and/or optical media, such as a random access memory (RAM), read-only memory (ROM), non-volatile RAM (NVRAM), electrically-erasable programmable ROM (EEPROM), Flash memory, hard disk drives (HDD), magnetic tape drives, optical storage technology (e.g., compact disc (CD), digital versatile disc (DVD), and/or Blu-ray Disc), or any other memory components.

The one or more memory components may include (e.g., store) the data described herein. For example, the one or more memory components may include the application data (e.g., application records) included in the application data store 108 and the similarity data (e.g., a similarity matrix) included in the similarity data store 504. The one or more memory components may also include instructions that may be executed by the one or more processing units. For example, a memory may include computer-readable instructions that, when executed by the one or more processing units, cause the one or more processing units to perform the various functions attributed to the modules and data stores described herein.

The one or more I/O components may refer to electronic hardware and software that provides communication with a variety of different devices. For example, the one or more I/O components may provide communication between other devices and the one or more processing units and memory components. In some examples, the one or more I/O components are configured to communicate with a computer network. For example, the one or more I/O components may be configured to exchange data over a computer network using a variety of different physical connections, wireless connections, and protocols. The one or more I/O components may include, but are not limited to, network interface components (e.g., a network interface controller), repeaters, network bridges, network switches, routers, and firewalls. In some examples, the one or more I/O components include hardware and software that is configured to communicate with various human interface devices, including, but not limited to, display screens, keyboards, pointer devices (e.g., a mouse), touchscreens, speakers, and microphones. In some examples, the one or more I/O components include hardware and software that is configured to communicate with additional devices, such as external memory (e.g., external HDDs).

In some implementations, the systems 100 and 500 are systems of one or more computing devices (e.g., a computer search system and a computer search result enhancement system) that are configured to implement the techniques described herein. Put another way, the features attributed to the modules and data stores described herein may be implemented by one or more computing devices. Each of the one or more computing devices may include any combination of electronic hardware, software, and/or firmware described above. For example, each of the one or more computing devices may include any combination of processing units, memory components, I/O components, and interconnect components described above. The one or more computing devices of the systems 100 and 500 may also include various human interface devices, including, but not limited to, display screens, keyboards, pointing devices (e.g., a mouse), touchscreens, speakers, and microphones. The computing devices may also be configured to communicate with additional devices, such as external memory (e.g., external HDDs).

The one or more computing devices of the systems 100, 500 may be configured to communicate with the network 106. The one or more computing devices may also be configured to communicate with one another via a computer network. In some examples, the one or more computing devices include one or more server computing devices configured to communicate with the user device(s) 104 (e.g., receive search queries 200, transmit search results 600, and, in some examples, promote existing applications within the search results 600, or insert new applications into the search results 600, as described herein), gather data from data source(s) 120, index the data, store the data, and store other documents and/or information. The one or more computing devices reside within a single machine at a single geographic location in some examples. In other examples, the one or more computing devices may reside within multiple machines at a single geographic location. In still other examples, the one or more computing devices may be distributed across a number of geographic locations.

What is claimed is:

1. A method comprising:
receiving a search query from a user device;
performing a search for software applications using the search query;
generating a preliminary set of one or more software applications identified during the search, wherein each of the one or more software applications of the preliminary set is associated with a rank value that indicates a relative rank of the software application among the one or more software applications of the preliminary set;
generating a similarity set of one or more software applications that are each similar to at least one of the one or more software applications of the preliminary set;
generating a modified set of one or more software applications based on the preliminary set, based on the similarity set, and based on the one or more rank values associated with the one or more software applications of the preliminary set; and
transmitting the modified set to the user device.

2. The method of claim 1,
wherein performing the search for the software applications using the search query comprises identifying one or more application records included in a data store based on one or more matches between one or more terms of the search query and one or more terms included in the identified one or more application records, each application record including at least one software application, and
wherein generating the preliminary set comprises selecting the one or more software applications of the preliminary set from the identified one or more application records.

3. The method of claim 1, wherein generating the similarity set comprises:
for each of at least one of the one or more software applications of the preliminary set, identifying a software application;
determining a similarity value that indicates a degree of similarity of the identified software application relative to the software application of the preliminary set;
when the similarity value exceeds a threshold similarity value, including the identified software application in the similarity set; and
when the similarity value does not exceed the threshold similarity value, excluding the identified software application from the similarity set.

4. The method of claim 1, wherein generating the similarity set comprises generating the similarity set based on one or more of the search query and the preliminary set.

5. The method of claim 4, wherein generating the similarity set based on the search query comprises:
determining that the search query is sufficiently broad based on one or more terms of the search query; and
generating the similarity set in response to determining that the search query is sufficiently broad.

6. The method of claim 4, wherein generating the similarity set based on the preliminary set comprises at least one of:
determining that the one or more software applications of the preliminary set are sufficiently relevant to the search query based on one or more result scores associated with the preliminary set, and generating the similarity set in response to the determination; and
determining that the one or more software applications of the preliminary set are sufficiently similar to one another based on one or more similarity scores associated with the preliminary set, and generating the similarity set in response to the determination.

7. The method of claim 1, wherein generating the similarity set comprises:
identifying a plurality of software applications that are each similar to at least one of the one or more software applications of the preliminary set;
assigning a boost score to each of the plurality of software applications; and,
for each software application of the plurality of software applications:
when the boost score associated with the software application exceeds a threshold boost score, including the software application in the similarity set; and
when the boost score does not exceed the threshold boost score, excluding the software application from the similarity set.

8. The method of claim 1, wherein generating the similarity set comprises:
identifying a plurality of software applications that are each similar to at least one of the one or more software applications of the preliminary set; and
selecting the one or more software applications of the similarity set from the identified plurality of software applications based on a pre-defined set of one or more rules.

9. The method of claim 1, wherein generating the modified set based on the preliminary set, based on the similarity set, and based the one or more rank values comprises:
determining that a software application included in the preliminary set is also included in the similarity set;
increasing the rank value associated with the software application based on determining that the software application is included in the preliminary set and the similarity set; and
generating the modified set to include the one or more software applications of the preliminary set including the software application associated with the increased rank value.

10. The method of claim 1, wherein generating the modified set based on the preliminary set, based on the similarity set, and based on the one or more rank values comprises:
determining that a software application included in the similarity set is not included in the preliminary set;
adding the software application to the preliminary set based on the one or more rank values; and
generating the modified set to include the one or more software applications of the preliminary set and the software application added to the preliminary set.

11. The method of claim 10, wherein adding the software application included in the similarity set to the preliminary set based on the one or more rank values comprises:
generating a new rank value associated with the software application, wherein the new rank value indicates a relative rank of the software application relative to the one or more software applications of the preliminary set; and
inserting the software application among the one or more software applications of the preliminary set based on the new rank value and the one or more rank values.

12. The method of claim 1, wherein generating the modified set comprises generating the modified set based on one or more of the search query, the preliminary set, and the similarity set.

13. The method of claim 12, wherein generating the modified set based on the search query comprises:
determining that the search query is sufficiently broad based on one or more terms of the search query; and
generating the modified set in response to determining that the search query is sufficiently broad.

14. The method of claim 12, wherein generating the modified set based on the preliminary set comprises at least one of:
determining that the one or more software applications of the preliminary set are sufficiently relevant to the search query based on one or more result scores associated with the preliminary set, and generating the similarity set in response to the determination; and
determining that the one or more software applications of the preliminary set are sufficiently similar to one another based on one or more similarity scores associated with the preliminary set, and generating the similarity set in response to the determination.

15. The method of claim 12, wherein generating the modified set based on the similarity set comprises:
determining that the one or more software applications of the similarity set are sufficiently similar to the one or more software applications of the preliminary set based on one or more similarity scores associated with the similarity set and the preliminary set; and
generating the modified set in response to the determination.

16. The method of claim 1, wherein transmitting the modified set to the user device comprises:
determining that the one or more software applications of the modified set are more relevant to the search query than the one or more software applications of the preliminary set; and
transmitting the modified set to the user device in response to the determination.

17. The method of claim 16, wherein determining that the one or more software applications of the modified set are more relevant to the search query than the one or more software applications of the preliminary set comprises determining based on one or more of the search query, the preliminary set, the similarity set, and the modified set.

18. The method of claim 1, wherein the search query comprises a first search query included in a set of one or more specified search queries, the method further comprising:
receiving a second search query not included in the set of the one or more specified search queries from the user device;
performing a search for software applications using the second search query;
generating a set of one or more software applications identified during the search; and
transmitting the generated set to the user device without modifying the generated set.

19. A system comprising one or more computing devices configured to:
receive a search query from a user device;
perform a search for software applications using the search query;
generate a preliminary set of one or more software applications identified during the search, wherein each of the one or more software applications of the preliminary set is associated with a rank value that indicates a relative rank of the software application among the one or more software applications of the preliminary set;
generate a similarity set of one or more software applications that are each similar to at least one of the one or more software applications of the preliminary set;
generate a modified set of one or more software applications based on the preliminary set, based on the similarity set, and based on the one or more rank values associated with the one or more software applications of the preliminary set; and
transmit the modified set to the user device.

20. A non-transitory computer-readable storage medium comprising instructions that cause one or more computing devices to:
receive a search query from a user device;
performing a search for software applications using the search query;
generating a preliminary set of one or more software applications identified during the search, wherein each of the one or more software applications of the preliminary set is associated with a rank value that indicates a relative rank of the software application among the one or more software applications of the preliminary set;
generating a similarity set of one or more software applications that are each similar to at least one of the one or more software applications of the preliminary set;
generating a modified set of one or more software applications based on the preliminary set, based on the similarity set, and based on the one or more rank values associated with the one or more software applications of the preliminary set; and
transmitting the modified set to the user device.
